(19) United States
(12) Patent Application Publication
(10) Pub. No.: US 2012/0248346 A1
(43) Pub. Date: Oct. 4, 2012

(54) LIMITED-USE RADIATION ATTENUATING SHIELDS, LINERS FOR RADIATION ATTENUATING SHIELDS AND METHODS

(75) Inventors: Prataprai Chowdhary, Round Rock, TX (US); Ashok C. Khandkar, Salt Lake City, UT (US)

(73) Assignee: BloXR, Corporation, Salt Lake City, UT (US)

(21) Appl. No.: 13/436,344

(22) Filed: Mar. 30, 2012

Related U.S. Application Data
(60) Provisional application No. 61/469,783, filed on Mar. 30, 2011.

(51) Int. Cl. G21F 3/02; B65D 85/00; B23P 11/00; B32B 3/06

(52) U.S. Cl. 250/516.1; 428/99; 428/40.1; 206/526; 29/428; 29/426.2

(57) ABSTRACT

Wearable radio-opaque shields may be formed from relatively low-cost materials, which may include a non-toxic radio-opaque material. The use of such materials may render the wearable radio-opaque shields suitable for limited use or even for single use. The useful life of a wearable radio-opaque shield may be extended, and hygiene improved, by way of a liner configured for assembly with the wearable radio-opaque shield. Methods for using and disposing of wearable radio-opaque shields and liners are also disclosed.

### CROSS-REFERENCE TO RELATED APPLICATIONS

This application is a non-provisionat of U.S. Provisional Patent Application No. 61/469,783 titled “Disposable Radiation Attenuating Garments,” filed Mar. 30, 2011, pending (the “'783 Application”). A claim for the benefit of priority to the '783 Application is hereby made pursuant to 35 U.S.C. §119(e). This application is also related to U.S. patent application Ser. No. 13/421,961 filed Mar. 16, 2012. The entire disclosure of each of the foregoing applications is, by this reference, hereby incorporated herein.

### TECHNICAL FIELD

The present invention relates generally to protective shields worn by humans exposed to harmful ionizing radiation and, more specifically, to wearable shields used to protect healthcare providers, patients, security personnel and other operators of equipment that generates ionizing radiation. More specifically, the present invention relates to wearable radio-opaque shields in which one or more layers of particulate environmentally friendly radio-opaque material are encased between two containment layers. The present invention also relates generally to liners for radio-opaque shields.

### BACKGROUND OF RELATED ART

Modern imaging technologies, such as x-ray, fluoroscopy, and computer tomography (CT), all of which employ ionizing radiation (e.g., x-rays, etc.), have revolutionized diagnostic radiology. The benefits of using imaging technologies are many: living tissues can be non-invasively visualized; radiographic techniques may now be used to diagnose conditions that were once identified with laparoscopic techniques; and diagnosis with radiography is noninvasive, fast and painless. As a result, by one estimate, in 2008 over 178 million x-rays were performed in the United States alone. Over 19,500 CT scans are performed in the United States each day, subjecting each patient to the equivalent of between 30 to about 500 chest radiographs per scan. Annually, about four million CT scans are performed on children. In flict, roughly half of all of the most advanced procedures that use ionizing radiation are conducted in the United States alone

Unfortunately, the increase in the use of radiographic procedures comes with a downside: the average American receives the highest per capita dosage of ionizing radiation in the world, with the average dose growing six-fold over the last couple of decades. With the increase in exposure to ionizing radiation comes an increased risk of long term damage (e.g., cancer, genetic damage that may affect future generations, etc.) to each individual exposed to ionizing radiation. The risk of radiation-induced damage is particularly prevalent among health care professionals who are repeatedly exposed to ionizing radiation, either directly or incidentally.

Recognition of the potentially grave effects of repeated exposure to ionizing radiation has led to the development of radiation-blocking garments. As an example, thyroid collars protect the thyroid gland, which is known to be extremely sensitive to ionizing radiation, from excessive kvels of ionizing radiation. Traditionally, radiation-blocking garments have been manufactured by dispersing lead (Pb) powder, or other heavy metal powders such as tungsten (W), antimony (Sb), tin (Sn) or mixtures of metals that attenuate ionizing radiation, throughout polymeric materials, such as rubber, vinyl and other elastomers. When lead or heavy metal powder particles are dispersed throughout a polymer, the resulting composite must be relatively thick and cumbersome to provide a desired level of radiation attenuation. Polymer-lead/heavy metal composites are also heavy and uncomfortable for clinicians, who often require protection from ionizing radiation for several hours in a typical day. With repeated use, radiation attenuating garments typically become soiled, for example, as the clinician sweats, by fluids from patients, etc. Unfortunately, conventional radiation attenuating garments are not configured for regular cleaning or sanitization. Thus, they can lack the level of hygiene typically associated with and expected of a healthcare setting.

While the use of thinner lead sheets or foils could provide comparable radiation protection with less weight, they lack the pliability needed for use in garments.

The use of materials other than lead, in conjunction with polymeric matrices, to attenuate ionizing radiation has resulted in some weight savings, Nonetheless, lead-free composites are often bulkier than lead-based composites, providing minor weight savings, and typically offering less protection from ionizing radiation than lead-based composites.

### SUMMARY

Various embodiments of wearable radio-opaque shields are disclosed. Wearable radio-opaque shields may also be more simply referred to herein as “shields” and as “articles.” The construction of a wearable radio-opaque shield may render it suitable for limited use, or cven for disposal after a single use. The phrase “limited use,” as employed herein, is intended to encompass wearable radio-opaque shields that are configured for temporary use, as well as single-use, or disposable, shields.

In some embodiments, a wearable radio-opaque shield may comprise a non-toxic radio-opaque material, which may lend to the disposability of the shield. A wearable radio-opaque shield may also have a light-weight construction, which may be at least partially attributable to the materials and amounts of materials that are used to form the shield. U.S. patent application Ser. No. 12/897,611 (the “'611 Application”), the entire disclosure of which is, by this reference, hereby incorporated herein, describes light-weight, non-toxic radio-opaque sheets from which a wearable radio-opaque shield may be fabricated. In a specific embodiment, the radio-opaque sheet used to form a wearable radio-opaque shield includes two flexible films between which radio-opaque material is captured.

A wearable radio-opaque shield may comprise a thyroid collar. When placed over the front of an individual's neck, a disposable thyroid collar prevents ionizing radiation to which the individual is exposed from reaching the individual's thyroid. A limited-use thyroid collar may be formed from relatively (when compared with conventional thyroid collars) inexpensive materials.

Alternatively, a wearable radio-opaque cap may prevent exposure of an individual's brain to ionizing, radiation. Such a shield may, accordingly, comprise a cap or other article configured to be worn on the individual's head.

A plurality of light-weight, wearable radio-opaque shields (e.g., thyroid collars, caps, etc.) may be packaged together, providing a system for preventing at least a portion of at least one individual's body from being exposed to ionizing radiation. In its most basic embodiment, such a system includes a package and a plurality of wearable radio-opaque shields. The package, which may include an interior configured to contain the plurality of wearable radio-opaque shields, at least temporarily holds the wearable radio-opaque shields together, and enables an individual to readily access one of the wearable radio-opaque shields for use.

The present invention also includes methods for using wearable radio-opaque shields. In such a method, a shield is placed on a portion of an individual's body, and remains in place while the individual is exposed to ionizing radiation. Once the individual is no longer exposed to ionizing radiation, the shield may be removed and stored for later re-use or it may be disposed. In embodiments where the radio-opaque material(s) of the shield is (are) non-toxic, disposal of the shield may simply include throwing it into a standard waste receptacle. A limited use shield may be used once before it is discarded, or it may be used multiple times during a predetermined period of time (e.g., a twenty-four hour period, a week, a month, etc.), then disposed of.

In another aspect, the present invention includes elements that reduce soiling of radio-opaque shields, whether wearable or not, including limited use shields. One embodiment of such an element is a finer configured for disposal between the shield and an individual on whom the shield is to be used (e.g., an individual who wears the shield, an individual over which a radio-opaque drape is placed, etc.). A liner my cover all or part of a single, inner surface (e,g., a surface configured to face an individual, a surface that may be exposed to contaminants, etc.) of a shield. Alternatively, a liner may be configured to cover more than one surface of a shield (e.g., wrap around edges of the shield, encase the shield, etc.). In embodiments where the shield is configured to be worn by or placed on an individual, a liner configured for use with the shield may be configured to absorb oil, perspiration, dirt and other soiling agents from the individual's body, and to prevent such soiling agents from adsorbing to a radio-opaque shield worn by the individual. Thus, a liner may increase the cleanliness of a shield, improving hygiene, and extend the useful life of the shield.

The configuration of a liner may enable its assembly with a radio-opaque shield and its disassembly from the shield. In some embodiments, a liner may have substantially the same configuration as that of an interior surface of the shield with the liner is intended to be used. A reusable embodiment of a liner may be configured for cleaning i.e, it may be reusable), while a disposable liner my be configured to be used once, or it may be configured for limited use (e.g., until the liner becomes visibly soiled; until an individual using the liner and the radio-opaque shield decides to clean or replace the liner, etc.).

Limited use liners may be provided to medical professionals or packaged together, like tissue or surgical gloves. In either embodiment, a liner may be provided in a package. The package may be configured to contain the liner or liners, and to enable an individual to readily access the liner for use.

In using a liner, a radio-opaque shield is oriented in such a way that a surface that is to be lined is exposed. A liner that corresponds to (e.g., is configured for use with) the shield may be oriented to substantially align with the shield, the liner is assembled with the shield, and the liner may be secured to the shield. The liner and shield may be aligned with, assembled with and, optionally, secured to one another in series or at substantially the same time. A liner may remain in place on its corresponding shield until its removal and disposal are desired. Removal may include detachment and disassembly of the liner from the shield.

Other aspects, as well as features and advantages of various aspects, of the present invention will become apparent to those of ordinary skill in the art through consideration of the ensuing description, the accompanying drawings and the appended claims.

### BRIEF DESCRIPTION OF THE DRAWINGS

In the drawings:

FIG. 1 illustrates an embodiment of a wearable radio-opaque shield, in which the shield comprises a thyroid collar;

FIG. 2 depicts another embodiment of wearable radio-opaque shield, where the shield comprises a cap;

FIGS. 3A and 3B illustrate an embodiment of a type of radio-opaque sheet that may be used in the fabrication of a wearable radio-opaque shield;

FIG. 4 shows a system in which a plurality of radio-opaque shields of the same type are packaged together;

FIG. 5 schematically illustrates assembly of a liner with a radio-opaque shield;

FIG. 6 depicts disassembly of a liner from a radio-opaque shield, as well as disposal of the liner; and

FIG. 7 shows a package including a plurality of liners for radio-opaque shields.

### DETAILED DESCRIPTION

The present invention includes wearable radio-opaque shields, or radiation attenuating shields. A wearable radio-opaque shield that incorporates teachings of the present invention is configured to be worn by an individual during exposure to ionizing radiation. In various embodiments, wearable radio-opaque shields may be configured to be worn on or over certain body parts, attenuating ionizing radiation to which such body parts may otherwise be exposed.

Specific embodiments of wearable radio-opaque shields include, but are not limited to, thyroid collars, caps and ionizing radiation-attenuating garments designed to be worn by an individual (e.g., a healthcare provider, such as a doctor, a physician's assistant, a nurse, a technician, etc.; security personnel; etc.) while the individual is exposed to ionizing radiation (e.g., during a medical procedure; in using x-ray scanners; etc.).

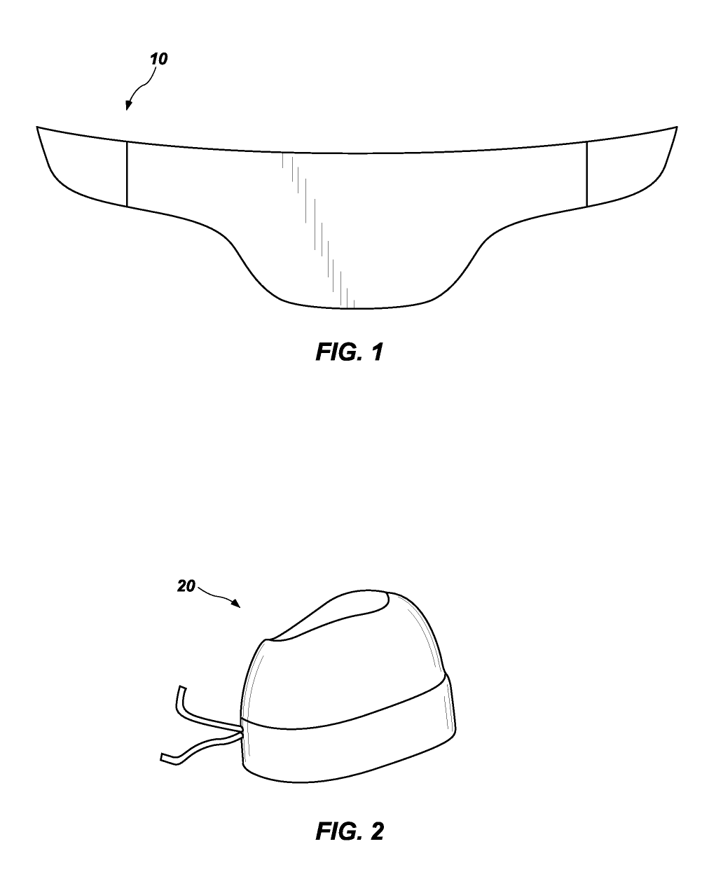

FIG. 1 depicts an embodiment of wearable radio-opaque shield that incorporates teachings of the present invention. Specifically, FIG. 1 illustrates an embodiment of thyroid collar 10; however, the present invention is not limited to any specific configuration of wearable radio-opaque shield. The thyroid collar 10 may include a relatively tow-cost radio-opaque material (when compared with the radio-opaque materials used to fabricate conventional thyroid collars). When a relatively low-cost material is used to fabricate a thyroid collar 10 or other wearable radio-opaque shield, the resulting article may also be inexpensive and, thus, may be considered to be configured for limited use or single use. In addition, the use of a non-toxic material that attenuates ionizing radiation may contribute to disposability of the article. In some embodiments, the radio-opaque material of the wearable radio-opaque shield 10 may comprise a material that may be thrown away with standard refuse.

In FIG. 2, another embodiment of wearable radio-opaque shield a cap 20 is illustrated. The cap 20 is configured to be worn on an individual's head, limiting exposure of the individual's head (including the individual's brain) to ionizing radiation. The cap 20 may be configured to be worn on as an individual and his or her head is oriented in an upright position (e.g., standing, sitting, etc.). Accordingly, the cap 20 may be configured to minimize fatigue on the individual's head. Thus, in some embodiments, the cap 20 may be made with lightweight materials that will apply less weight to an individual's head than would a cap made using conventional radio-opaque materials (leg., lead, etc.), if such a cap were even available. The cap 20 may also be disposable, which may result from a combination of factors, such as the use of low-cost materials and the use of non-toxic radio-opaque materials.

Without limiting the scope of the present invention, a wearable radio-opaque shield, such as a thyroid collar 10 or a cap 20, may comprise a radio-opaque sheet 30. The '611 Application discloses several embodiments of radio-opaque sheets that may be used to fabricate all or part of a wearable radio-opaque shield of the present invention.

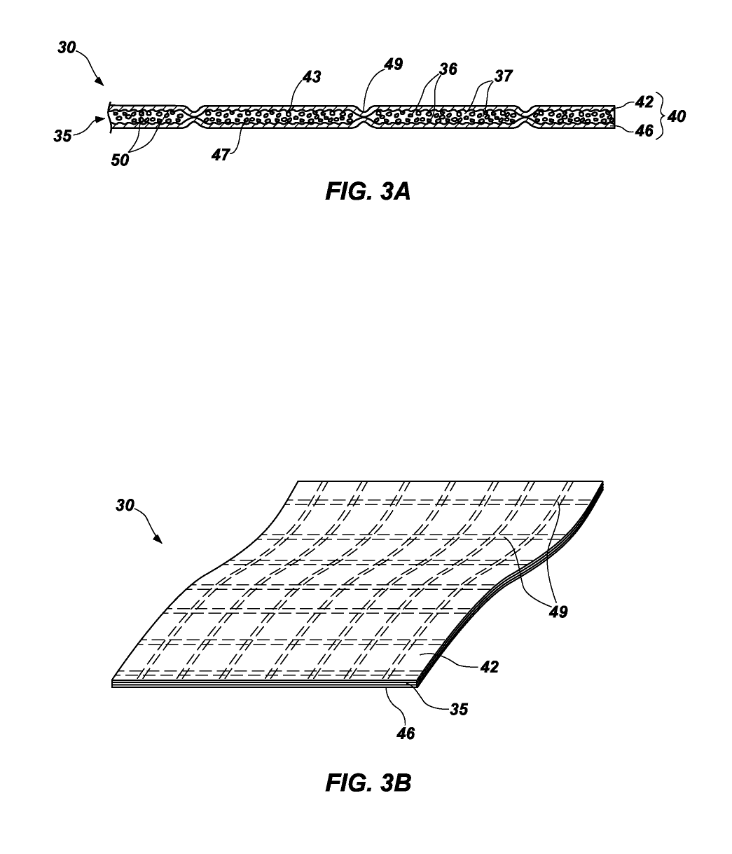

The radio-opaque sheet 30 may include a radio-opaque layer 35 carried by a substrate 40, as illustrated by FIGS. 3A and 313. some embodiments, the substrate 40 may include a pair of containment layers 42 and 46, between which the radio-opaque layer 35 may be sandwiched, Each containment layer 42, 46 may comprise a thin, flexible film. The material of each containment layer 42, 46 may conform somewhat to the shape of an object, such as the anatomy of the body part to be protected, over which a radio-opaque film that includes the containment layers 42 and 46 is positioned.

In some embodiments, the containment layers 42 and 46 may be configured in such a way as to enable folding of the radio-opaque sheet 30 of which they are a part. A variety of factors may enable folding of a radio-opaque sheet 30, including, without limitation, the material or Materials from which various elements (eg., the containment layers 42 and 46, etc.) of the radio-opaque sheet 30 are formed, as well as the thickness of various features (e.g,, the containment layers 42 and 46, etc.) of the radio-opaque sheet 30.

A variety of different materials are suitable for use as containment layers 42, 46, including, without limitation, polymers, papers, and fabrics. The material used as each containment layer 42, 46 may be selected on the basis of a number of factors, including, without limitation, the porosity of the material, water-resistance (which may be a function of porosity, the material itself, etc.), bacterial resistance (which may be a fnction of porosity, incorporation of antibacterial agents into the material, etc.), flexibility, feel, and any other factors. One or both of the containment layers 42 and 46 may attenuate ionizing radiation.

In some embodiments, each containment layer may comprise a polymer or a polymer-based material, More specifically, one or both containment layers 42, 46 may comprise a polymer film or a sheet of woven or non woven polymer fibers with paper-like or fabric-like characteristics. In other embodiments, one or both containment layers 42, 46 may comprise a polymer, but have a structure (e.g., fibers arranged in a way) that resembles paper or fabric.

By way of example, and not by way of limitation, each containment layer 42, 46 may have a thickness of about 15 mils (0.015 inch, or about 0.375 mm) or less. Of course, embodiments of radio-opaque sheets 30 that include containment layers 42, 46 of other thicknesses are also within the scope of the present invention.

In some embodiments, one or both containment layers 42 and 46 may include at least one surface 43, 47 with features 50, such as patterned or random texturing. Such features 50 may increase the effective surface area of the surface 43, 47 that carries the features 50 (e.g, the interior, or opposed, surfaces of the containment layers 42 and 46 depicted by FIG. 3A) and/or enhance adhesion between that containment layer 42, 46 and the adjacent radio-opaque layer 35.

The radio-opaque layer 35 of such a radio-opaque sheet 30 includes a radio-opaque material 36, which attenuates at least some frequencies (or wavelengths) of ionizing radiation. In some embodiments, the radio-opaque material 36 of the radio-opaque layer 35 may be in a particulate or powdered form. In such embodiments, the radio-opaque layer 35 may include a binder 37 that holds particles of the radio-opaque material 36 together.

As indicated previously herein, the radio-opaque material 36 may be non-toxic. In various embodiments, the radio-opaque material 36 may comprise or be based upon elemental species having atomic numbers of or greater than 52. Non-limiting examples of such elemental species include barium species, bismuth species and lanthanum species. in some embodiments, the radio-opaque material 36 may comprise an inorganic salt. Non-limiting examples of non-toxic, radio-opaque inorganic salts include barium sulfate and bismuth oxide.

In embodiments where the radio-opaque layer 35 includes a binder 37, any material that will hold particles of the radio-opaque material 36 together without causing a substantial decrease in the density of the radio-opaque material 36 or an undesirable decrease in the ability of the radio-opaque material 36 to attenuate ionizing radiation may be used as the binder 37. The binder 37 may hold particles of radio-opaque material 36 together loosely, it may provide a stronger bond between adjacent particles, andlor it may enable the formation of a smooth uniform coating, a film or a foam. Examples of such materials include, but are not limited to, polyvinyl alcohol (PVA), polyvinyl hutyrol (PVB), polyethylene glycol (PEG), glycerine, capric triglyceride, cetyl alcohol, glyceryl sterate and combinations of any of these materials.

In a radio-opaque layer 35 in which particles of radio-opaque material 36 are held together with a binder 37, the radio-opaque material 36 may, in some mbodiments, comprise at least about 50% of the weight of the radio-opaque layer 35, with the binder 37 comprising about 50% or less of the weight of the radio-opaque layer 35. Other embodiments of radio-opaque layers 35 include about 75% or more of the radio-opaque material 36, by weight, and about 25% or less of the binder 37, by weight. In still other embodiments, the radio-opaque material 36 may comprise about 97% or more of the weight of the radio-opaque layer 35, while the binder 37 comprises only up to about 3% of the weight of the radio-opaque layer 35.

In some embodiments, a radio-opaque layer 35 of a radio-opaque sheet 30 of the present invention has a thickness of about 40 mils (0.040 inch, or 1 mm) or less. In other embodiments, a radio-opaque sheet 30 may include a radio-opaque layer 35 with a thickness of about 25 mils (0.020 inch, or about 0.6 mm) or less. In still other embodiments, the radio-opaque layer 35 of a radio-opaque sheet 30 may have a thickness of about mils (0.015 inch, or about 0.375 mm) or less, about mils (0.010 inch, or about 0.25 mm) or less, or about 5 mils (0.005 inch, or about 0.125 mm) or less.

The ability of the radio-opaque layer 35 to attenuate ionizing radiation depends upon a number of actors, including, without limitation, the attenuating ability of each radio-opaque material 36 from which the radio-opaque layer 35 is formed, the relative amounts of radio-opaque material 36 and binder 37 in the radio-opaque layer 35, and the thickness of the radio-opaque layer 35.

The containment layers 42, 46 may be secured to the radio-opaque layer 35, and to one another, in a number of different ways. As an example, in embodiments where the radio-opaque layer 35 includes a particulate or powdered radio-opaque material 36 and a binder 37, the binder 37 may adhere or otherwise secure the containment layers 42, 46 to the radio-opaque layer 35 and, thus, to one another. In other embodiments, the containment layers 42, 46 may be directly or indirectly secured to one another at a plurality of spaced apart locations 49 (e.g, in a matrix of spaced apart points, a grid of spaced apart row tines and column etc.), as shown in FIGS. 3A and 3B, with the radio-opaque layer 35 occupying substantially all other areas (i.e., substantially all of the area) between the containment layers 42 and 46. For example, the containment layers 42 and 46 may be directly fused to one another (e.g., by thermal bonding, solvent bonding, etc.). As another example, adhesive material may be disposed between a plurality of spaced apart locations on the containment layers 42 and 46.

Known processes may be used to manufacture a radio-opaque sheet 30. In some embodiments, the radio-opaque material 36 and binder 37 may substantially homogeneously mixed in a solvent. The solvent may comprise a carrier solvent within which the binder 37 is provided, or a separately added solvent. more specific mbodiments, the resulting slurry may have a solids content, or solids loading, of about 75% wriw to about 80% W/W. The slurry may then be applied to one of the containment layers 42 in a manner that will result in the formation of a thin film or a foam comprising the radio-opaque layer 35 over the containment layer 42. In specific embodiments, a doctor blade or simulated doctor blade technique may be employed to form the radio-opaque layer 35. The other containment layer 46 may then be applied over the radio-opaque layer 35. In other embodiments, one or more rollers may be employed to form and disperse the radio-opaque layer 35 between the containment layers 42, 46. In a specific embodiment suitable for mass production, roll calendaring techniques may be used.

In addition to the radio-opaque sheet 30, a wearable radio-opaque shield (e.g., a thyroid collar 10 such as that shown in FIG. 1, a cap 20 such as that shown in FIG. 2, etc.) of the present invention may include an outer shell 32, The outer shell 32 may fulfill a variety of functions, including, without limitation, protecting the radio-opaque sheet 30 and enabling the radio-opaque sheet 30 to be worn over a particular portion of an individual's body. Accordingly, suitable materials from which the outer shell 32 may be formed include, but are not limited to, fabrics, paper-like polymer fiber materials, and the like.

A wearable radio-opaque shield (e.g., a thyroid collar 10 such as that shown in FIG. 1, a cap such as that shown in FIG. 2, etc) may be fabricated, at least in part, from a radio-opaque sheet 30 (FIGS. 3A and 3B). Fabrication of a wearable radio-opaque shield may include known techniques, including, without limitation, sealing a radio-opaque sheet 30 at locations where the outer peripheral edges of a radio-opaque shield are to be located (e.g., with heat, adhesives, etc.) and cutting the radio-opaque sheet 30 at such locations to define the outer peripheral edges of the wearable radio-opaque shield or a portion thereof.

In some embodiments of a fabrication method, these processes may completely define a wearable radio-opaque shield. In other embodiments, the element or elements that have been defined from a radio-opaque sheet 30 may be assembled with other elements of a wearable radio-opaque shield, such as an outer shell 32, fasteners, a garment or garment features, or the like. Assembly of the radio-opaque portion of a wearable radio-opaque shield with other features of the shield may include the use of thermal bonding processes, adhesives, sewing or any other suitable technique.

Wearable radio-opaque shields that incorporate teachings of the present invention may be made available in a plurality of different sizes, enabling selection of a size appropriate for the individual on which the wearable radio-opaque shield is to be used. some embodiments, the shape and or size of a wearable radio-opaque shield may altered (e.g., by cutting, etc.) just prior to placing it on an individual to tailor it to that individual.

As an example of the use of a wearable radio-opaque shield (e.g., a thyroid collar 10 such as that shown in FIG. 1, a cap 20 such as that shown in FIG. 2, etc.), the wearable radio-opaque shield may be placed on a portion of an individual's body. As the individual is exposed to ionizing radiation (either directly or as scattered radiation), the wearable radio-opaque shield may at least partially shield that portion of the individual's body from the ionizing radiation. When the individual is no longer exposed to ionizing radiation, the wearable radio-opaque shield may be removed and discarded. In some enibodiments, a disposable wearable radio-opaque shield may be used once, then discarded. In other embodiments, the wearable radio-opaque shield may be used two or more times during a particular period of time (a work day, twenty-four hours, a week, a month, etc.), then discarded.

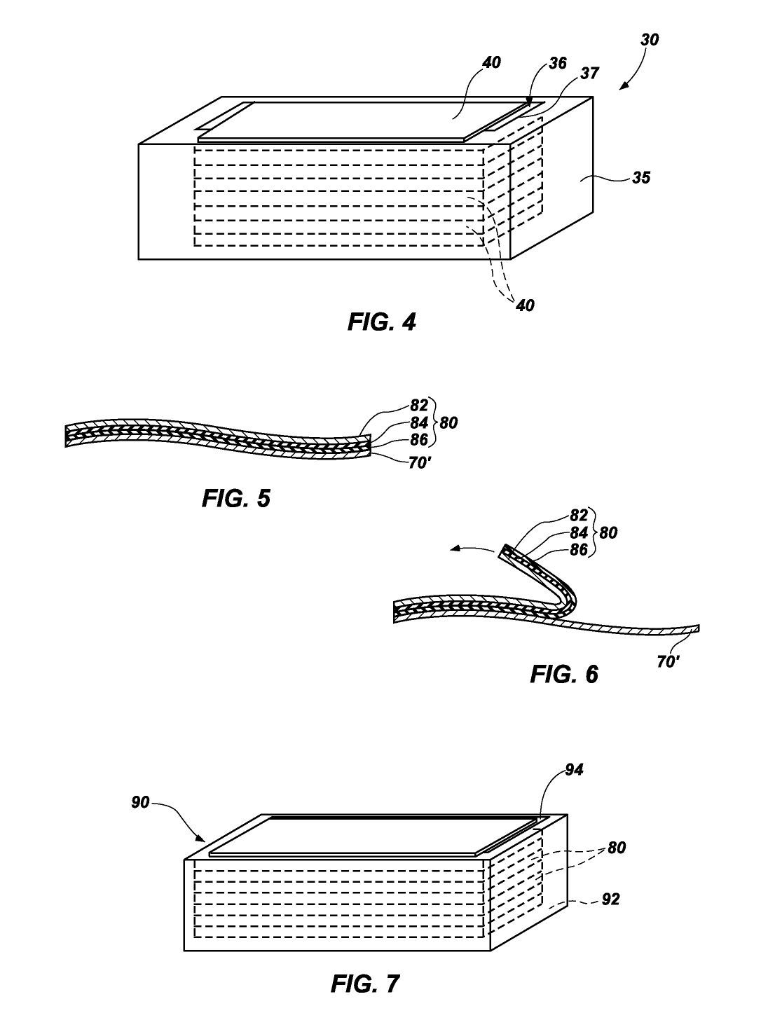

Referring now to FIG. 4, an embodiment of a package 60 of wearable radio-opaque shields 70 is depicted. Package 60 includes a container 62 that at least temporarily holds a plurality of wearable radio-opaque shields 70 together. The container 62 may include an interior 64, within which the plurality of wearable radio-opaque shields 70 may be disposed. Of course, other means for at least temporarily securing the plurality of wearable radio-opaque shields 70 together are also within the scope of the present invention. The container 62 may also include an opening 66 that facilitates removal of one wearable radio-opaque shield 70 from the interior 64 of the container 62 while the container 62 continues to hold one or more other wearable radio-opaque shields 70.

The wearable radio-opaque shields 70 of the package 60 may be disposable or intended for limited use. The package 60 may include means for helping an individual user understand that the wearable radio-opaque shields 40 are intended for limited use (e.g., to be disposed of after a single use, a certain period of time, or when their use is no longer desired by the individual, etc.). Such means may include the availability of additional wearable radio-opaque shields 70 within the interior 64 of the container 62, instructions provided with the package 60 (e.g, on the container 62, etc.), or the like.

In some embodiments, all of the wearable radio-opaque shields 70 of the package 60 may be of the same type as one another. For example, all of the radiation shields 70 may comprise thyroid collars 10 (FIG. 1), caps 20 (FIG. 2) or any other suitable wearable radio-opaque shield.

Turning now to FIGS. 5 through 7, improving hygiene and/or extending the useful life of a wearable radio-opaque shield may be desirable. This may be true even in embodiments where the wearable radio-opaque shield incorporates inexpensive materials, relative to the materials of used in conventional radio-opaque shields (e.g., thyroid collars, etc.). A liner 80 configured for assembly with (e.g., for placement over at least a portion of at least one of surface of, for enveloping, etc.) a radio-opaque shield may improve hygiene and extend the useful life of the shield, Without limiting the scope of the present invention, a liner 80 may improve hygiene bypreventing or minimizing soiling of the shield (whether wearable, configured for placement over all or part of an inidividuat's body (e.g., ad/ape, etc.), etc.), The prevention and/or minimization of soiling may also extend the useful life of the shield by keeping the shield clean and, thus, by reducing or eliminating wear-inducing cleaning of the shield.

In various embodiments, and as illustrated by FIG. 5, a liner 80 may be configured for assembly with at least an interior surface 72 of a radio-opaque shield 70′. In some embodiments, the liner 80 may also be configured to extend over edges 74 of the radio-opaque shield 70′. In particular, the liner 80 may be designed to cover portion of the radio-opaque shield 70′ that will contact an individual's skin or that would otherwise be subject to soiling by the individual as the radio-opaque shield 70′ is worn by or placed over apart of the individuars body. More specifically, a liner 80 may provide a physical barrier that prevents contaminants, such as perspiration or oil, on the skin of an individual with whom the radio-opaque shield 70′ is used from soiling the radio-opaque shield 70′.

A liner 80 may also prevent or minimize soiling of a radio-opaque shield 70′ by absorbing contaminants from the skin of the individual with whom the radio-opaque shield 70′ is used, Thus, the liner 80, or at least a portion of the liner 80, may include an absorbent layer 82 of a suitable absorbent material. Various embodiments of such a material include, but are not limited to, natural fabrics e.g., cotton, etc.), fabrics including synthetic materials (e.g, fleece, so-called “microfiber” wicking materials, etc.), absorbent papers, absorbent paper-like materials (e.g., paper-like materials formed from polymer fibers, etc.), and the like.

The absorbent layer 82 may be carried by (e.g., laminated with, coated with, etc.) a barrier film 84, which may prevent contaminants from passing through absorbent layer 82 to the radio-opaque shield 70′. Accordingly, the barrier film 84 may comprise a substantially non-porous polymer that will provide a barrier that is both water resistant and oil resistant, and that will withstand salts and other contaminants that may be present on an individual's skin.

An attachment element 86 of the liner 80 may be configured to secure the liner 80 to a radio-opaque shield 70′. In a specific embodiment, the attachment element 86 may comprise a low-tack, reusable, pressure-sensitive adhesive, which enables release of the liner 80 from a surface, and its subsequent adhesion to the same or another surface. Of course, the attachment element may alternatively include other embodiments of attachment elements (e,g,, hook and/or loop-type fasteners, etc.).

When assembly of the liner 80 with a radio-opaque shield 70′ is desired, the liner 80 may be aligned with a portion of the radio-opaque shield 70′ that the liner 80 is intended to cover, and assembled with the radio-opaque shield 70′, The liner 80 may be secured to that portion of the radio-opaque shield 70′. In some embodiments, the acts of alignment, assembly, and securing may be effected substantially concurrently with one another.

Once a liner 80 has been visibly soiled, or replacement of the liner 80 is otherwise desired, the liner 80 may be removed from the radio-opaque shield 70′, as depicted by FIG. 6. Removal of the liner 80 from the radio-opaque shield 70′ may include releasing any attachment element 86 from the radio-opaque shield 70′. In some embodiments, removal may be quite simple, consisting essentially of, or even completely of, peeling the liner 80 from the radio-opaque shield 70′.

Turning now to FIG, 7, a plurality of liners 80 may be packaged together. In embodiments where liners 80 include attachment elements 86 (FIGS. 5 and 6) comprising a low-tack, reusable, pressure sensitive adhesive, the plurality of liners 80 may be superimposed relative to one another, with adjacent liners 80 adhered to each other. In some embodiments, the liners 80 may be stored within an interior 92 of a package 90, and removed from the interior 92 of the package 90 through an opening 94 in the package 94 when needed.

Although the foregoing description contains many specifics, these should not be construed as limiting the scope of the invention or of any of the appended claims, but merely as providing information pertinent to some specific embodiments that may fall within the scopes of the invention and the appended claims, Other embodiments of the invention may also be dcvised which lie within the scopes of the invention and the appended claims. Features from different embodiments may be employed in combination. The scope of the invention is, therefore, indicated and limited only by the appended claims and their legal equivalents. All additions, deletions and modifications to the invention, as disclosed herein, that fall within the meaning and scopes of the claims are to be embraced thereby.

What is claimed:

1. A limited use wearable radio-opaque shield, comprising a non-toxic radio-opaque material.

2. The limited use wearable radio-opaque shield of claim 1, wherein the non-toxic radio-opaque material comprises an inorganic salt.

3. The limited use wearable radio-opaque shield of claim 2, wherein the inorganic salt comprises at least one of barium sulfate and bismuth oxide.

4. The limited use wearable radio-opaque shield of claim 2, wherein the non-toxic radio-opaque material is carried by a flexible substrate.

5. The limited use wearable radio-opaque shield of claim 4, wherein the flexible substrate comprises at least two sheets that are at least partially superimposed, with at least some of the non-toxic radio-opaque material between the at least two sheets.

6. The limited use wearable radio-opaque shield of claim 5, wherein each sheet of the a least two sheets comprises a polymer.

7. The limited use wearable radio-opaque shield of claim 1, further comprising a removable liner configured to absorb contaminants.

8. The limited use wearable radio-opaque shield of claim 7, wherein the removable liner includes a releasable attachment element that enables removal of the liner from a remainder of the limited use wearable radio-opaque shield.

9. The limited use wearable radio-opaque shield of claim 8, wherein the attachment element comprises a releasable adhesive.

10. The limited use wearable radio-opaque shield of claim 1, comprising a thyroid collar or a cap.

11. A radio-opaque cap, comprising a radio-opaque element configured to be worn on a head of an individual while the individual is in an upright position and remains mobile.

12. The radio-opaque cap of claim 11, comprising anon-toxic radio-opaque material.

13. The radio-opaque cap of claim 11, further comprising a removable liner configured to absorb contaminants.

14. A system for providing at least a portion of a body of at least one individual with protection from ionizing radiation, comprising:
a package; and
a plurality of limited use wearable radio-opaque shields configured to be worn over at least the portion of the body of the at least one individual, the plurality of limited use wearable radio-opaque shields being at least temporarily held together by the package.

15. The system of claim 14, wherein the package includes an interior within which the plurality of limited use wearable radio-opaque shields are at least temporarily contained.

16. The system of claim 14, wherein each limited use wearable radio-opaque shield of the plurality of limited use wearable radio-opaque shields includes a non-toxic radio-opaque material.

17. The system of claim 14, wherein each limited use wearable radio-opaque shield of the plurality of limited use wearable radio-opaque shields is substantially identical to another limited use wearable radio-opaque shield of the plurality of limited use wearable radio-opaque shields.

18. The system of claim 17, wherein each limited use wearable radio-opaque shield of the plurality of limited use wearable radio-opaque shields comprises a thyroid collar.

19. The system of claim 17, wherein each limited use wearable radio-opaque shield of the plurality of limited use wearable radio-opaque shields comprises a radio-opaque cap.

20. The system of claim 14, further comprising:
a plurality of liners, each liner of the plurality of liners configured to be assembled with a limited use wearable radio-opaque shield of the plurality of limited use wearable radio-opaque shields to minimize contamination of the limited use wearable radio-opaque shield when worn by an individual.

21. The system of claim 20, wherein adjacent liners of the plurality of liners are temporarily secured to one another with an attachment element of one of the adjacent liners.

22. The system of claim 21, wherein the attachment elemen c prises a releasable adhesive material.

23. The system of claim 20, further comprising:
a package with an interior for containing the plurality of liners.

24. A method for protecting at least a portion of a body of an individual from ionizing radiation, comprising:
placing a limited use wearable radio-opaque shield over at least the portion of the body of the individual;
temporarily exposing the individual to above-ambient levels of ionizing radiation;
after the individual is no longer exposed to the above-ambient levels of ionizing radiation, removing the limited use wearable radio-opaque shield from the individual; and
disposing of the limited use wearable radio-opaque shield.

25. The method of claim 24, wherein placing the limited use wearable radio-opaque shield comprises placing a limited use wearable radio-opaque shield that includes a non-toxic radio-opaque material over at least he portion of the body of the individual.

26. The method of claim 25, wherein disposing comprises placing the limited use wearable radio-opaque shield in a standard waste receptacle.

27. The method of claim 26, wherein disposing is effected within a month of initially placing the limited use wearable radio-opaque shield over at least the portion of the body of the individual.

28. The method of claim 27, wherein disposing is effected after a single use of the limited use wearable radio-opaque shield by the individual.

29. The method of claim 24, further comprising:
assembling a liner with the limited use wearable radio-opaque shield to minimize contamination of the limited use wearable radio-opaque shield as the limited use wearable radio-opaque shield is in place over at least the portion of body of the individual.

30. The method of claim 29, further comprising:
removing the liner from the limited use wearable radio-opaque shield following visible soiling of the liner; and
replacing the liner with a clean liner.

31. A liner for use with a wearable radio-opaque shield, comprising:
an absorbent layer configured to be removably positioned over at least a part of a wearable radio-opaque shield susceptible to contamination by an individual by whom the wearable radio-opaque shield is configured to be worn.

32. The liner of claim 31, further comprising:
a barrier for preventing contaminants absorbed by the absorbent layer from contacting the wearable radio-opaque shield.

33. The liner of claim 31, further comprising:
a releasable attachment element for removably securing the absorbent layer to the wearable radio-opaque shield.

34. The liner of claim 33, wherein the releasable attachment element comprises a releasable adhesive.

35. A hygienic system for increasing the life of a wearable radio-opaque shield, comprising:
a plurality of liners, each liner of the plurality of liners configured to be assembled with a limited use wearable radio-opaque shield of the plurality of limited use wearable radio-opaque shields to minimize contamination of the limited use wearable radio-opaque shield when worn by an individual.

36. The hygienic system of claim 35, wherein adjacent liners of the plurality of liners are temporarily secured to one another with an attachment element of one of the adjacent liners.

37. The hygienic system of claim 36, wherein the attachment element comprises a releasable adhesive material.

38. The hygienic system of claim 35, further comprising:
a package with an interior for containing the plurality of liners.

39. A method for using a wearable radio-opaque shield, comprising:
assembling a liner with a wearable radio-opaque shield to minimize contamination of the wearable radio-opaque shield as the wearable radio-opaque shield is in place over at least the portion of body of the individual.

40. The method of claim 39, further comprising:
removing the liner from the wearable radio-opaque shield following visible soiling of the liner; and
replacing the liner with a clean liner.
